(19) United States
(12) Patent Application Publication
(10) Pub. No.: US 2014/0189532 A1
(43) Pub. Date: Jul. 3, 2014

(54) EDITING TEXT-BASED COMMUNICATIONS

(71) Applicant: VERIZON PATENT AND LICENSING INC., Basking Ridge, NJ (US)

(72) Inventors: Sundar Sivaraman, Tamil Nadu (IN); NarayanaDhoss Gopalakrishnan, Tamil Nadu (IN); Ganesh Ramasamy, Tamil Nadu (IN); Maria M. Sagayaraj, Tamil Nadu (IN); Poothabalan Somasundaram, Tamil Nadu (IN); Krishnakumar Sundaram, Erode (IN); Saravanan Vijayakumar, Tamil Nadu (IN); Habeeb Abdulquiyum, Tamil Nadu (IN)

(73) Assignee: Verizon Patent and Licensing Inc., Basking Ridge, NJ (US)

(21) Appl. No.: 13/729,667

(22) Filed: Dec. 28, 2012

(51) Int. Cl. G06F 3/048

(52) U.S. Cl. CPC G06F 3/048
USPC 715/753

(57) ABSTRACT

A device may receive information regarding an edit to a segment of a message in a text-based communication between a first user device and a second user device. The information regarding the edit may be entered at the first user device. The device may determine a location in the message that corresponds to the information regarding the edit and may determine a particular quantity of characters associated with the information regarding the edit. The device may also replace the segment of the message with the particular quantity of characters and may provide the replaced segment to the first user device and the second user device.

### BACKGROUND

Text-based communication is a popular form of communication for users. Two popular types of text-based communications include text messaging and instant messaging. After a user enters and transmits a text message, the user may determine that the information in the text message was incorrect. Correction of this may be difficult, especially if some time has elapsed between sending the text message and the discovery of incorrectness or if correction of the text may, for some reason, confuse the person receiving the correction.

### BRIEF DESCRIPTION OF THE DRAWINGS

FIGS. 1A and 1B depict an overview of an example implementation described herein;

FIG. 2 is a diagram of an example environment in which systems and/or methods described herein may be implemented;

FIG. 3 depicts a diagram of example components of a device of FIG. 2;

FIG. 4 depicts a flow chart of an example process according to implementations described herein; and

FIGS. 5A-5C depict text correction according to implementations described herein.

### DETAILED DESCRIPTION OF PREFERRED EMBODIMENTS

The following detailed description refers to the accompanying drawings. The same reference numbers in different drawings may identify the same or similar elements.

A system and/or method, as described herein, may receive information regarding an edit to a segment of a text message in a communication between a first user device and a second user device, determine a particular quantity of characters associated with the information regarding the edit, and replace the segment of the text message with the particular quantity of characters. In some implementations, the edited segment may be provided, for display, to the first user device and the second user device along with alert information including an indication associated with the edited segment.

The systems and methods described herein are directed to editing a segment of a text message from a first user device to a second user device. However, the systems and methods described herein are applicable to any type of text-based communication including, for example, instant messaging, email, etc.

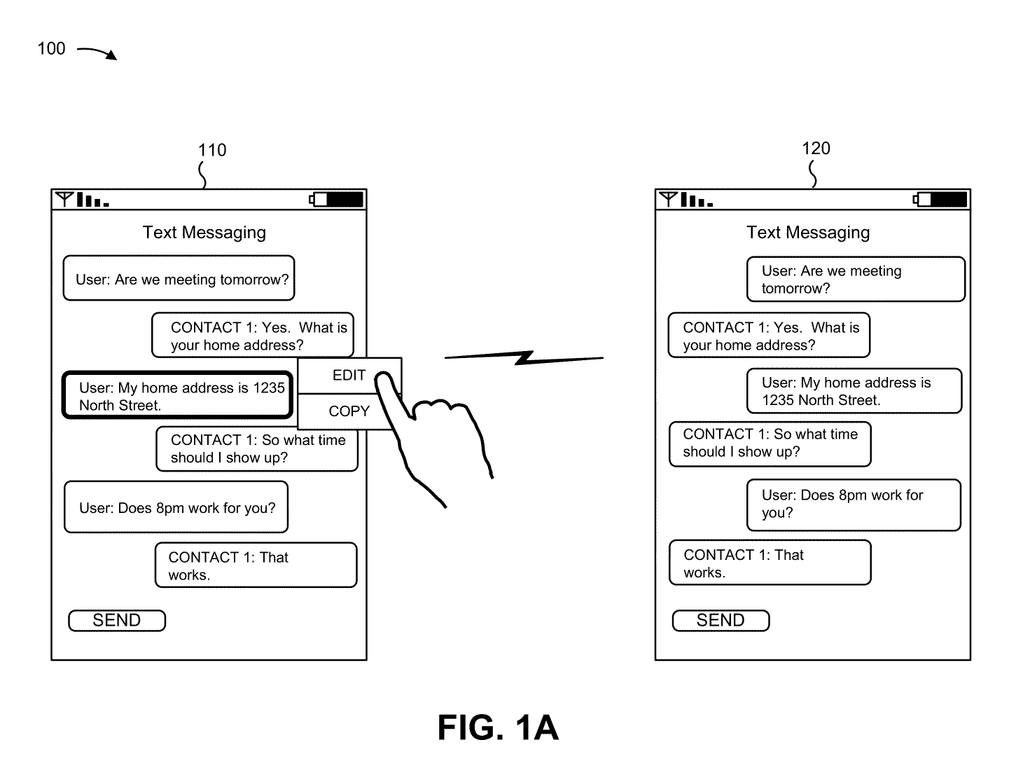

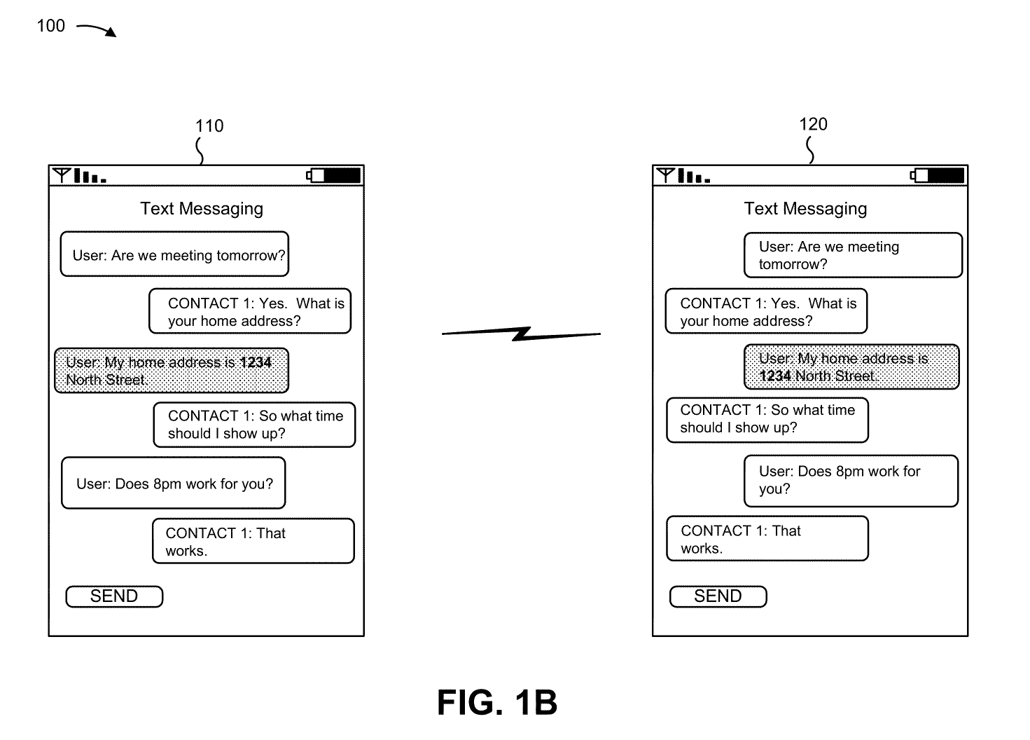

FIGS. 1A and 1B are diagrams illustrating an overview 100 of an example implementation described herein. With reference to FIG. 1A, assume a user of user device 110 (called “User” in overview 100) communicates with a user of user device 120 (called “CONTACT 1” in overview 100) via a text messaging application. During the conversation, CONTACT 1 may type a question (e.g., “What is your home address?”), and User may respond to the question (e.g., by providing an address). After entering the address, User may determine that the address is incorrect. In response, User may select the text box that includes the address information (e.g., “My home address is 1235 North Street”) and may edit the text message in the text box.

For example, User may touch or click the text box on the screen of user device 110. Based on this touch, a pop-up window may be provided on the screen of user device 110 that provides User with one or more options. As illustrated in FIG. 1A, the pop-up window may include a “edit” option and a “copy” option. In some implementations, the pop-up window may include additional options including, for example, an “insert” option, a “cancel” option, etc. User may, for example, select the “edit” option to edit one or more characters, in the text message, in the corresponding text box.

For example, assuming that User incorrectly entered his street number as “1235,” User may select the incorrect character(s) (e.g., “5”) and may replace the incorrect character(s) with the correct character(s) (e.g., “4”). The text messaging application may receive the new character(s) and may replace the incorrect character(s) (e.g., “5”) with the correct character(s) (e.g., “4”) and may provide this information for display on user device 110 and user device 120.

With reference to FIG. 1B, the text box that includes the changed character(s) may be modified to alert User and CONTACT 1 of the change. For example, the text box may be bolded or shaded to visually alert User and CONTACT 1 that one or more characters in the text box were changed. In addition, the changed character(s) received from User may be highlighted or bolded to visually alert User and CONTACT 1 of the change. In addition or alternatively, an arrow or some other marker may be disposed adjacent to (and pointing to or otherwise denoting) the text box that has been changed. Similarly, a pop-up window or other notification may, for a period of time, illustrate the edited text (and perhaps the old text). In some implementations, the change to the text message may only be performed by the user device 110 that originally transmitted the text message (e.g., User), and the information indicating the change to the text message may only be reflected by the other user device 110 (e.g., CONTACT 1).

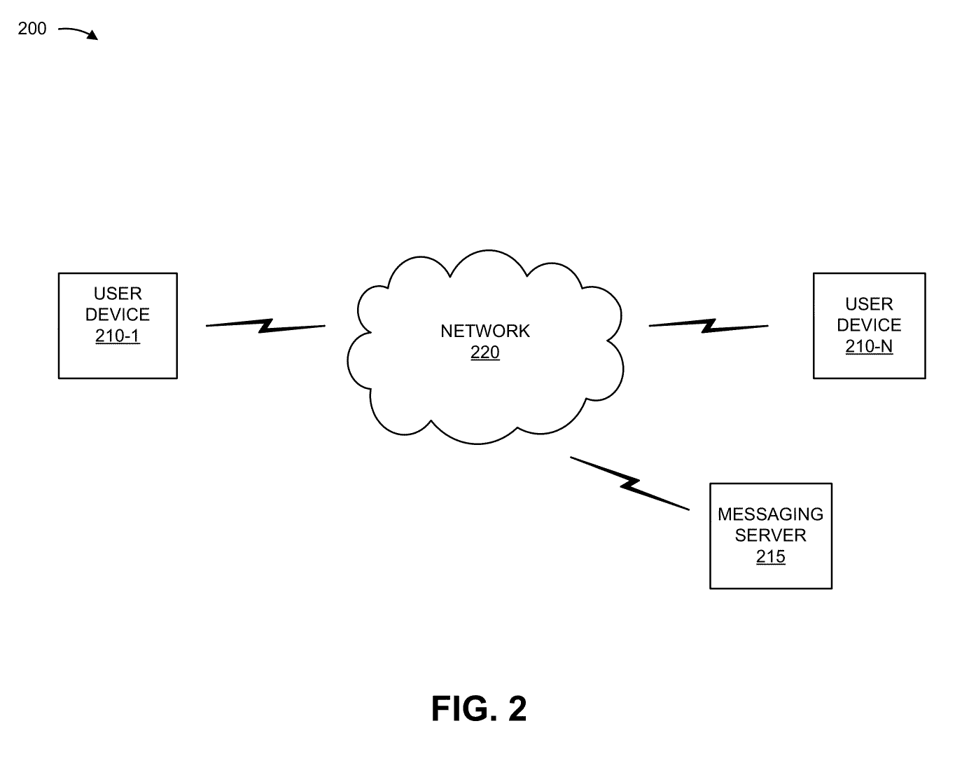

FIG. 2 is a diagram of an example environment 200 in which systems and/or methods described herein may be implemented. As illustrated, environment 200 may include a set of user devices 210-1 through 210-N (N≧1) (hereinafter referred to collectively as “user devices 210,” and individually as “user device 210”) and a messaging server 215 interconnected by a network 220. Components of environment 200 may interconnect via wired and/or wireless connections.

User device 210 may include a device capable of performing text-based communications via a network, such as network 220. For example, user device 210 may correspond to a mobile communication device (e.g., a smart phone or a personal digital assistant (PDA)), a portable computer device (e.g., a laptop or a tablet computer), a gaming device, a desktop computer, or some other device.

Messaging server 215 may include one or more server devices, and/or other types of devices, that gather, process, search, store, and/or provide information in a manner described herein. In some implementations, messaging server 215 may receive and store information regarding one or more text messages transmitted between user devices 210. In some implementations, messaging server 215 may also receive and store one or more changes made to the transmitted text messages along with information that indicates the user device 210 that provided the change, the user device 210 that received information regarding the change, etc.

In some implementations, messaging server 215 may also include information from one or more user devices 210 indicating how the user(s) of user device(s) 210 would like to be alerted to a change to a previously transmitted text message. For example, messaging server 215 may receive information from a user of user device 210 that indicates that the user would like user device 210 to vibrate, emit a sound, provide a display, etc. when a change to a previously transmitted text message is received by messaging server 215 and provided to user device 210.

Network 220 may include one or more wired and/or wireless networks. For example, network 220 may include a cellular network, a public land mobile network (“PLMN”), a second generation (“2G”) network, a third generation (“3G”) network, a fourth generation (“4G”) or LTE network, a fifth generation (“5G”) network, other types of network such as a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

Although FIG. 2 shows example components of environment 200, in other implementations, environment 200 may include different components, differently arranged components, or additional components than those depicted in FIG. 2. In some implementations, one or more components of environment 200 may perform one or more tasks described as being performed by one or more other components of environment 200.

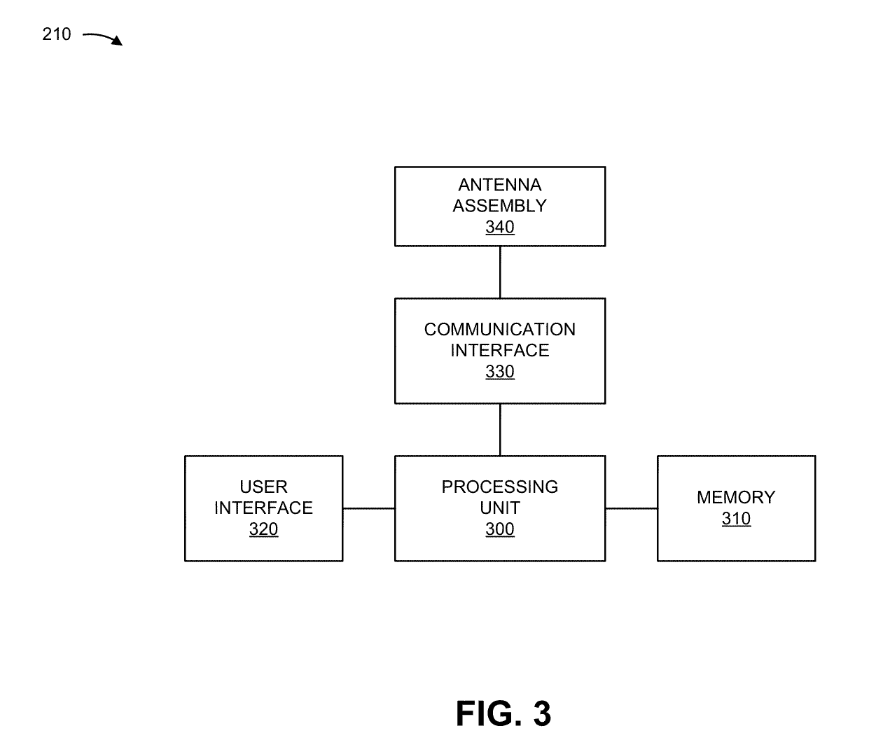

FIG. 3 is a diagram of example internal components of user device 210. As illustrated, user device 210 may include a processing unit 300, memory 310, a user interface 320, a communication interface 330, and/or an antenna assembly 340.

Processing unit 300 may include a processor, a microprocessor, an application specific integrated circuit (ASIC), a field programmable gate array (FPGA), or the like. Processing unit 300 may control operation of user device 210 and its components. In one implementation, processing unit 300 may control operation of components of user device 210 in a manner described herein.

Memory 310 may include a random access memory (RAM), a read-only memory (ROM), and/or another type of memory to store data and instructions that may be used by processing unit 300.

User interface 320 may include mechanisms for inputting information to user device 210 and/or for outputting information from user device 210. Examples of input and output mechanisms might include buttons (e.g., control buttons, keys of keypad, a joystick, etc.) or a touch screen interface to permit data and control commands to be input into user device 210; a speaker to receive electrical signals and output audio signals; a microphone to receive audio signals and output electrical signals; a display to output visual information (e.g., text input into user device 210); a vibrator to cause user device 210 to vibrate; and/or a camera to receive video and/or images.

Communication interface 330 may include, for example, a transmitter that may convert baseband signals from processing unit 300 to radio frequency (RF) signals and/or a receiver that may convert RF signals to baseband signals. Alternatively, communication interface 330 may include a transceiver to perform functions of both a transmitter and a receiver. Communication interface 330 may connect to antenna assembly 340 for transmission and/or reception of the RF signals.

Antenna assembly 340 may include one or more antennas to transmit and/or receive RF signals over the air. Antenna assembly 340 may, for example, receive RF signals from communication interface 330 and transmit them over the air, and receive RF signals over the air and provide them to communication interface 330. In one implementation, for example, communication interface 330 may communicate with a network and/or devices connected to a network (e.g., network 130).

User device 210 may perform various operations described herein. User device 210 may perform these operations in response to processing unit 300 executing software instructions included in a computer-readable medium, such as memory 310. A computer-readable medium may be defined as a non-transitory memory device. A memory device may include memory space within a single storage device or memory space spread across multiple storage devices.

Software instructions may be read into memory 310 from another computer-readable medium or from another device via communication interface 330. When executed, software instructions stored in memory 310 may cause processing unit 300 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

Although FIG. 3 shows example internal components of user device 210, in other implementations, user device 210 may contain fewer, different, or additional components than depicted in FIG. 3. In still other implementations, one or more components of user device 210 may perform one or more tasks described as being performed by one or more other components of user device 210.

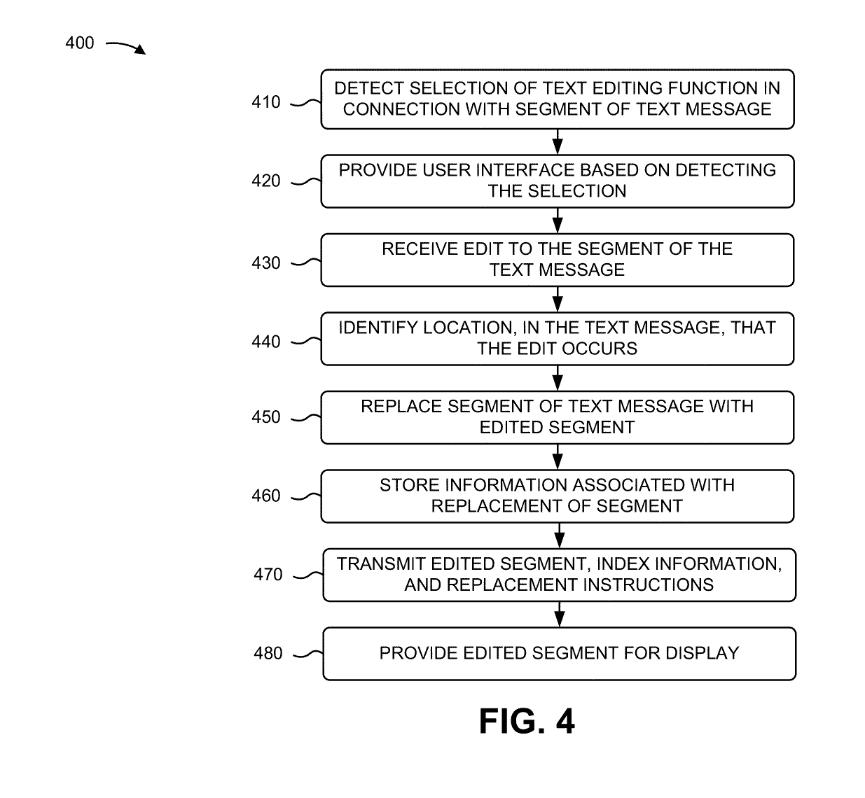

FIG. 4 is a flowchart of an example process 400 relating to editing information. In some implementations, process 400 may be performed by user device 210. In some implementations, one or more blocks of process 400 may be performed by one or more devices instead of, or possibly in conjunction with, user device 210.

Process 400 may include detecting selection of a text editing function in connection with a segment of a text message (block 410). For example, a user of user device 210-1 may communicate, using a text messaging application, with another user of user device 210-N. During the conversation, the user of user device 210 may determine that one or more characters of a previously entered text message should be changed. Based on this determination, the user of user device 210 may select a text editing function to initiate the changing of the one or more characters.

Process 400 may include providing a user interface based on detecting the selection (block 420). For example, when the text messaging application detects the selection of the text editing function, the text messaging application may transmit information regarding the detection to a text editing application for processing. In this implementation, the text messaging application may, based on detecting the selection, activate the text editing application and instruct the text editing application to begin processing the detected selection.

In some implementations, the text editing application may detect the selection of the text editing function. In these implementations, the text editing application may monitor the user's interaction with the text messaging application. Thus, when the user selects the text editing function in connection with the text messaging application, the text editing application may detect this selection. In this way, the text editing function may be running in the background each time the user is running the text messaging application.

Based on the detection, the text editing application may provide a user interface for display on user device 210. The user interface may include one or more options for editing one or more characters of the text message. For example, the user interface may include a “Select All” option, an “Edit” option, a “Copy” option, and/or a “Paste” option. These options are provided by way of example. In practice, additional or different options may be provided in the user interface. In some implementations, the user interface may be provided as a pop-up window. In some implementations, the user interface may be provided as a window on a separate screen. In some implementations, the user interface may be part of the user interface provided in connection with the text messaging application.

Process 400 may include receiving an edit to the segment of the text message (block 430). For example, the user may select one or more characters for editing and may provide one or more characters to replace the one or more selected characters. The text editing application may receive information regarding the one or more characters provided by the user and may record this information.

Process 400 may include identifying a location, in the segment of the text message, which corresponds to the edit (block 440). For example, the text editing application may maintain an index of information related the communication between the user and the other user. When a text message is entered and transmitted, the text editing application may parse the text message and determine a number of characters in the text message. For example, if the text message “9944516894” is entered by the user of user device 210 that transmits the text message and transmitted to user device 210 that receives the text message, the text editing application may determine that this text message is ten characters long and may create an index that includes ten entries (e.g., entry “0” through entry “9”). Each character of the text message may be associated with a corresponding entry of the index (e.g., “9” is associated with entry “0,” “9” is associated with entry “1,” “4” is associated with entry “2,” etc.).

In addition to creating an index for each text message, the text editing application may create another index that includes information that allows both user devices 210 to identify the particular text message that is being edited. In some implementations, the other index may include an entry for each text message exchanged between the user and the other user. For example, if the user and the other user have transmitted several text messages during the communication (e.g., four text messages—two text messages transmitted from the user and two text messages transmitted from the other user), the texting editing application may create the other index that includes four entries (e.g., an entry associated with each of the four text messages).

In some implementations, the other index may include other information that would allow both user devices 210 to identify the particular text message. For example, the other index may associate information identifying the text message with information relating to a date and/or time that the text message was sent or received. As another example, each user device 210 may associated a sequence number with each text message that is sent or received as part of a conversation between the user and the other user. The other index may associate the sequence number with the text message.

Process 400 may include replacing the segment of the text message with the edited segment (block 450). For example, based on the one or more characters that the user edits, the text editing application may associate the one or more edited characters with the corresponding entry in the index. For example, if the user selects “99” from the text message for editing and replaces these characters with “88,” the text editing application may update the index corresponding to this text message by associating entry “0” with “8” and entry “1” with “8.”

Process 400 may include storing information associated with the replacement of the segment (block 460). For example, the text editing application may store information regarding the one or more changed characters along with the corresponding index that includes information regarding this change.

Process 400 may include transmitting the edited segment, index information, and replacement instructions (block 470). For example, the text editing application may transmit the edited segment, index information, and replacement instructions to the text messaging application. For example, if the user replaces “99” with “88,” the text editing application may transmit the “88” and index information that indicates that the first “8” should be associated with entry “0” of the index and the second “8” should be associated with entry “1” of the index. The text editing application may also determine, using the other index, the appropriate text message that is associated with the edited segment and may transmit information regarding the determined text message to the text messaging application with instructions to replace the first two characters of the determined text message with “88.”

In some implementations, the replacement instructions may include one or more instructions regarding how the user device 210 that receives the edited segment should process the edited segment. For example, the replacement instructions may indicate that only the edited segment should be replaced. Based on the above example, only the “88” would be replaced with the “99” and the rest of the text message (e.g., “44516894”) would not be replaced. In another implementation, the entire text message associated with the edited segment may be replaced. Thus, in this implementation, the text message “8844516894” may be replaced with a new text message that includes the edited segment (e.g., “9944516894”).

Process 400 may include providing the edited segment for display (block 480). For example, the text messaging application may provide one or more indications for display on user device 210 to alert the user and/or the other user of a change to a segment of a text message. In some implementations, the text messaging application may highlight and/or bold the changed segment of the text message. In some implementations, the text messaging application may provide a visual indication, such as a pop-up window or separate text box, indicating that a segment of a text message was changed. This visual indication may provide information regarding the change, such as, for example, the edited segment, a line number corresponding to the edited segment, etc. In some implementations, the text messaging application may scroll up in the conversation and display the edited segment. In some implementations, the text messaging application may cause the edited segment and/or the text message to blink to provide a visual indication of the edit.

In some implementations, the user of user device 210 may select how user device 210 should provide the indication. For example, the user of user device 210 may determine that user device 210 should, in addition to and/or instead of the above indications, provide one or more other indications, including, for example, a vibration, a sound, etc. In addition, the user of user device 210 may provide information indicating an order for providing the one or more indications. For example, the user may provide information indicating that user device 210 should vibrate and/or emit a sound, then provide the pop-up window, and then scroll up in the conversation to display the edited segment. In some implementations, the user may receive information regarding the indication in some other manner, including a random manner, a specific manner based on the a type of edit to the text message (e.g., a pop-up window if a segment of the text message is edited and a scroll up in the conversation to display an entire text message is edited, etc.). One or more other types of indications may also be provided to user device 210.

While FIG. 4 shows process 400 as including a particular quantity and arrangement of blocks, in some implementations, process 400 may include fewer blocks, additional blocks, or a different arrangement of blocks. Additionally, or alternatively, some of the blocks may be performed in parallel. In addition, while FIG. 4 shows process 400 including blocks performed by the text messaging application in conjunction with the text editing application, in some implementations, the text messaging application may perform one or more of the blocks described as being performed by the text editing application.

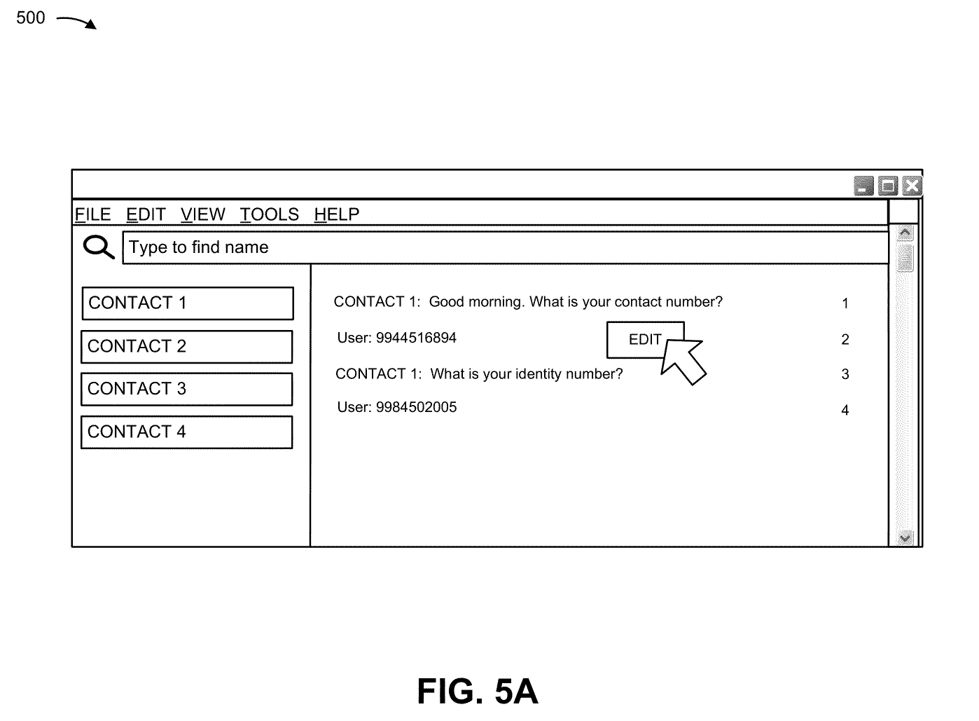

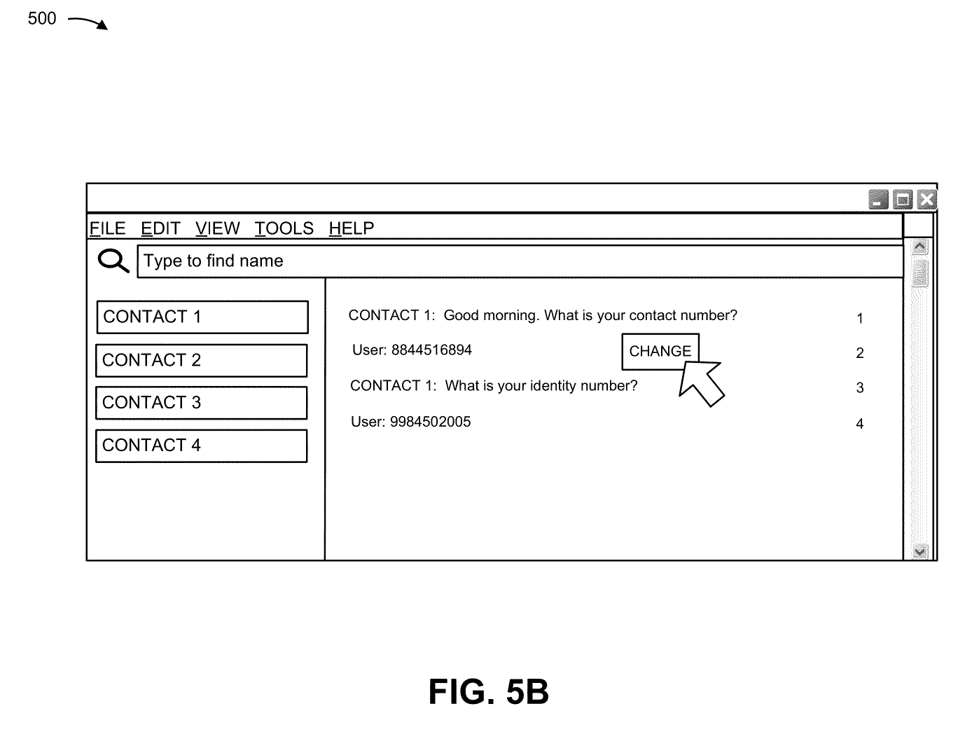

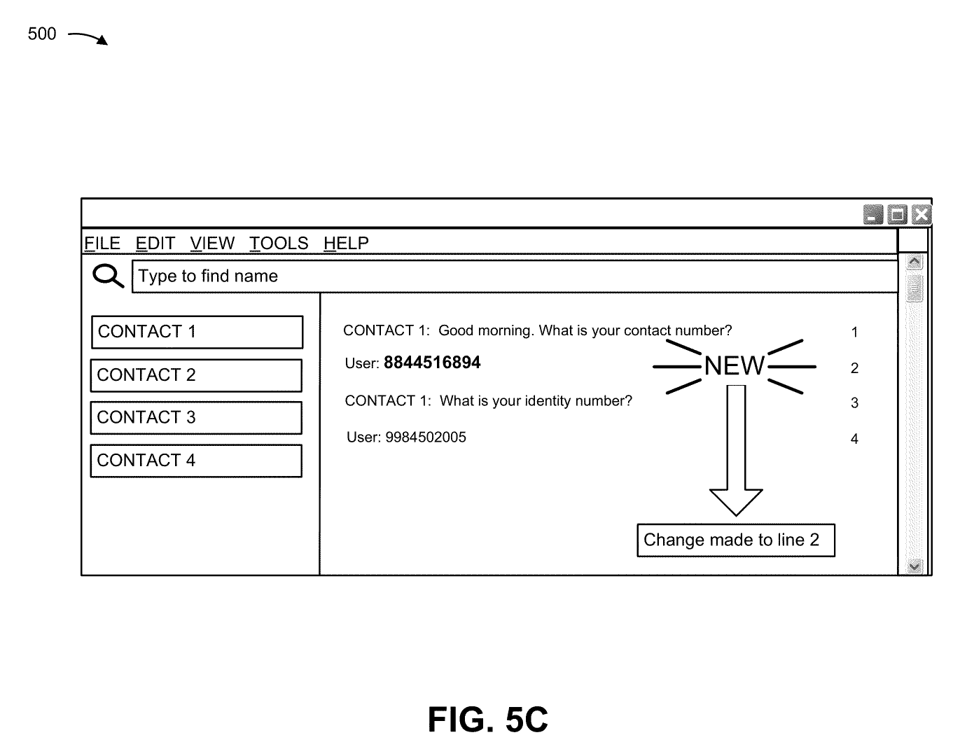

FIGS. 5A-5C depict an example 500 of process 400 described above with respect to FIG. 4. As illustrated in FIG. 5A, a user may communicate, using the text messaging application, with CONTACT 1. During the communication, the text messaging application may provide, for display, text messages transmitted from the user to CONTACT 1 and from CONTACT 1 to the user. During the conversation, the user may determine that a previously entered text message should be changed. As illustrated in FIG. 5A, the user may provide his contact number (e.g., “9944516894”), and, later in the conversation, may determine that some or all of the characters of this number should be changed. The user may select the text message associated with the contact number by, for example, clicking on or near the text message or touching on or near the text message. In some implementations, if only some of the characters of the text message should be changed, the user may select only that portion.

Based on the selection of the text message or the portion of the text message, the text editing application may receive, from the text messaging application, information regarding the selection and may provide, to the text messaging application, information regarding one or more options for the text messaging application to display. As illustrated in FIG. 5A, the text messaging application may provide an “edit” option, and the user may select this option to edit one or more characters of the text message, thereby creating an edited segment.

Assume that the user wants to change the first two characters (e.g., “99” to “88”). The user may perform this change by, for example, selecting the “99” and replacing the “99” with “88.” In some implementations, the user may select the entire text message and replace the entire text message with the new text message (e.g., “8844516894”). In some implementations, the user may provide the selection via one or more voice commands. For example, the user may speak the change, and the text messaging application and/or text editing application may interpret the voice command and perform the requested change.

The text editing application may receive the edited segment and transmit the edited segment, index information, and replacement instructions to the text messaging application. For example, the text editing application may receive the “88” and may determine that these characters correspond to the first and second entries in an index associated with the corresponding line (e.g., line 2). The text editing application may transmit the “88” and index information that indicates that an “8” should be associated with entry “0” and an “8” should be associated with entry “1” of the entry, in the index, corresponding to the selected text message. The text editing application may also transmit replacement instructions to the text messaging application to instruct the text messaging application to highlight the edited segment and/or text message, bold the edited segment and/or text message, provide a window alerting the user and/or CONTACT 1 that a text message has been edited, and/or scroll up in the communication to provide, for display, the edited segment.

The text messaging application may receive this information from the text editing application and may replace the text message with the edited text message. In some implementations, the text messaging application may replace only the edited characters in the text message. In addition, the text editing application may provide, to the text messaging application, information regarding one or more options, for the text messaging application to display, to prompt the user to confirm the change. For example, the text messaging application may provide, for display, a “change” option, as illustrated in FIG. 5B. When the user selects the “change” option, the text messaging application may confirm the change and provide the edited text message for display.

As illustrated in FIG. 5C, the text messaging application may highlight the edited text message. In some implementations, the text messaging application may also provide a visual indication, such as a pop-up window or separate text box that states that a segment of a text message was changed. As illustrated in FIG. 5C, the text messaging application may provide a flashing indicator (e.g., “NEW”) and a text box that includes “Change made to line 2” to alert CONTACT 1 to the change. In some implementations, the text messaging application may also provide one or more other indicators. For example, assume that the user and CONTACT 1 have been communicating for some time and many text messages have been transmitted between the two users. During the conversation, the user and CONTACT 1 may only be able to see a portion of the transmitted text messages. Therefore, if a text message, which is not currently displayed, is edited by the user, CONTACT 1 may need to scroll up in the conversation to determine where the edit occurs in the conversation. In some implementations, the text messaging application may automatically scroll up to the line corresponding to the edited text message and provide that line and one or more lines of text messages before and/or after that line for display. In some implementations, the text messaging application may also provide the line corresponding to the edited text message in the pop-up window.

In some implementations, the text editing application may store information regarding each edit that is made during a conversation. In addition to providing an indication of when an edit occurs, an indication, which includes information regarding each edit, may be provided at one or more other times such as, for example, in response to a request for the indication from the user and/or CONTACT 1, after a period of inactivity associated with the conversation, etc. This information may include, for example, each edited text message, line number information associated with each edited text message, a time stamp associated with each edited text message, and/or information regarding a user that performed the edit. This information may be provided, automatically, by the text messaging application based on instructions from the text editing application. In some implementations, this information may be provided by the text messaging application based on user selection of a prompt to receive this information.

The following are further examples of process 400 described above in relation to FIGS. 4 and 5A-5C. As a first example, assume a user is communicating with CONTACT 1 and enters a contact number (e.g., a telephone number) associated with another contact (e.g., CONTACT 2). For example, the user may enter “Jim's phone number is 703-555-1234” and may transmit this text message to CONTACT 1.

The text editing application may receive the contact number and may determine if a contact number for Jim is stored in the user's device. If a contact number is stored for Jim, the text editing application may compare the stored contact number with the phone number that the user entered and determine if there is a match. If the stored contact number and the entered phone number do not match, the text editing application may cause the text messaging application to provide an indication to the user that the stored contact number and the entered phone number do not match. In addition to providing the indication, the text editing application may also cause the text messaging application to provide a prompt to request the user to perform an action. For example, the user may be prompted to confirm that the entered phone number is correct and, if the entered phone number is correct, the user may be prompted to confirm if the user would like to update the stored contact number with the entered phone number. If the user selects an option to update the stored contact number with the entered phone number, the text messaging application may transmit this information to the text editing application, and the text editing application may update the stored contact information.

In another example, assume the user enters a text message and sends the text message to CONTACT 1. Before CONTACT 1 receives the entered text message, the user may determine that some or all of the information in the entered text message should be changed. Therefore, the user may recall the entered text message by, for example, selecting a recall option or transmitting a command to the text messaging application. Based on the user selecting the recall option or transmitting the command, the text messaging application may recall the entered text message before CONTACT 1 receives the entered text message. The text editing application may receive information regarding this recall and may provide instructions to the text messaging application to cause the text messaging application to provide a prompt to the user to provide the user with one or more options to, for example, edit some or all of the entered text message, replace the entered text message with a different text message, or discard the entered text message.

In another example, assume the user, with respect to FIGS. 5A-5C, edits his contact number by replacing “99” with “888.” Based on this edit, the text editing application may receive the edited segment and transmit the edited segment, index information, and replacement instructions to the text messaging application. For example, the text editing application may receive the “888” and may determine that the user has added a character. Therefore, the text editing application may update the index from ten entries (corresponding to “9944516894”) to eleven entries (corresponding to “88844516894”). The text editing application may determine that the new characters (e.g., “888”) are associated with the first, second, and third entries in the updated index. The text editing application may transmit the “888” and index information associated with the updated index that includes eleven entries and an “8” associated with entries “0,” “1,” and “2.” The text editing application may also transmit replacement instructions to the text messaging application to instruct the text messaging application to highlight the edited segment, bold the edited segment, provide a window alerting the user and/or CONTACT 1 that a text message has been edited, and/or scroll up in the communication to provide, for display, the edited segment.

In another example, assume the user communicates with several contacts over time. As illustrated in FIGS. 5A-5C, the user may store contact information associated with CONTACT 1, CONTACT 2, CONTACT 3, and/or CONTACT 4, and the text messaging application may store communication information associated with previous text messages exchanged with one or more of these contacts. The user may access the stored contact information by, for example, selecting the appropriate contact from the list of contacts. Based on this selection, the text messaging application may provide one or more previous text messages, between the user and a contact, for display. The user may review the information in the one or more previous text messages and may determine that a change to a text message, in the one or previous text messages, should be made.

Based on this determination, the user may select the appropriate text message by, for example, touching or clicking on or near the text message and may add one or more new characters, remove one or more characters, and/or replace one or more characters of the selected text message to edit the selected text message. The text editing application may receive the edited segment and may transmit the edited segment, the corresponding index information, and replacement instructions to the text messaging application to cause the text messaging application to generate a text message, including information associated with the edited segment, transmit the generated text message to the appropriate contact, and transmit alert information to alert the appropriate contact of the edit.

For example, the text messaging application may replace the segment of the text message with the edited segment in the corresponding line of the previous communication along with an indication that a part of the previous communication has been edited. In some implementations, the text messaging application may transmit a new text message to the appropriate contact that includes the edited segment and context information for the edit. For example and with respect to FIGS. 5A-5C, if the user edits his contact number, the text messaging application may transmit a text message to CONTACT 1 that states “The information previously provided by the user on Dec. 11, 2012 has been changed from ‘9944516894’ to ‘8844516894.’”

In some implementations, the text editing application may provide context information to the text messaging application by, for example, parsing one or more text messages entered before the edited segment to determine if the edited segment corresponds to a particular field. For example and with respect to FIGS. 5A-5C, the text editing application may determine that an edit to the text message “9944516894” corresponds to an edit to the user's contact number because the text message was entered in response to a text message that requested the user's contact number. Based on this context information, the text editing application may provide instructions to the text messaging application to provide the text message to CONTACT 1 with context information included in the text message. Based on the context information, the text messaging application may transmit a text message to CONTACT 1 that states “The user's contact number has been changed from ‘9944516894’ to ‘8844516894.’”

Systems and methods, as described herein, can be implemented in a user device that receives information regarding an edit to a segment of a text message, determines a particular quantity of characters associated with the information regarding the edit, and replaces the segment of the text message with the particular quantity of characters. The user device may, using an application, display the edited segment and alert information including an indication associated with the edited segment.

The foregoing description provides illustration and description, but is not intended to be exhaustive or to limit the implementations to the precise form disclosed. Modifications and variations are possible in light of the above disclosure or may be acquired from practice of the implementations.

As used herein, the term “component” is intended to be broadly construed as hardware, firmware, or a combination of hardware and software.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method comprising:
receiving, by a processor, information regarding an edit to a segment of a message in a text-based communication between a first user device and a second user device,
the message having been sent by the first user device and received by the second user device, and
the information regarding the edit entered at the first user device;
determining, by the processor, a location in the message that corresponds to the information regarding the edit;
determining, by the processor, a particular quantity of characters associated with the information regarding the edit;
replacing, by the processor, the segment of the message with the particular quantity of characters; and
providing, by the processor, the replaced segment and a command to the second user device,
the command being used by the second user device to:
replace the segment of the message with the replaced segment, and
display the message including the replaced segment.

2. The method of claim 1, further comprising:
providing alert information at the second user device,
the alert information including an indication associated with the replaced segment.

3. The method of claim 2, where the alert information includes at least one of:
a pop-up window that includes information regarding the edit, or
a text box that includes information regarding the edit.

4. The method of claim 1, further comprising:
providing the message within a text box of a display of the first user device; and
modifying at least one characteristic of the text box based on the replaced segment.

5. The method of claim 1, further comprising:
parsing the message to determine a quantity of characters included in the message;
creating, based on parsing the message, an index associated with the parsed message;
determining a location, in the index, associated with the edit; and
providing the replaced segment and information associated with the index,
the information associated with the index being used to provide the replaced segment for display.

6. The method of claim 1, further comprising:
determining that information in the message matches information stored in the first user device; and
replacing, based on determining that the information in the message matches the information stored in the first user device and after receiving the information regarding the edit, at least a portion of the information stored in the first user device with the replaced segment.

7. The method of claim 1, further comprising:
storing information regarding a plurality of edits, the plurality of edits including the edit; and
providing, for display, a list including the information regarding the plurality of edits,
where the list is provided to the second user device.

8. A device comprising:
a processor to:
receive information regarding an edit to a segment of a message in a text-based communication between a first user device and a second user device,
the message having been sent by the first user device and received by the second user device, and
the information regarding the edit entered at the first user device;
determine a location in the message that corresponds to the information regarding the edit;
determine a particular quantity of characters associated with the information regarding the edit;
replace the segment of the message with the particular quantity of characters; and
provide the replaced segment and a command to the second user device,
the command being used by the second user device to:
replace the segment of the message with the replaced segment, and
display the message including the replaced segment.

9. The device of claim 8, where the processor is further to:
provide alert information at the second user device,
the alert information including an indication associated with the replaced segment.

10. The device of claim 9, where the alert information includes at least one of:
a pop-up window that includes information regarding the edit, or
a text box that includes information regarding the edit.

11. The device of claim 8, where the processor is further to:
provide the message within a text box of a display of the first user device; and
modify at least one characteristic of the text box based on the replaced segment.

12. The device of claim 8, where the processor is further to:
parse the message to determine a quantity of characters included in the message;
create, based on parsing the message, an index associated with the parsed message;
determine a location, in the index, associated with the edit; and
provide the replaced segment and information associated with the index,
the information associated with the index being used to provide the replaced segment for display.

13. The device of claim 8, where the processor is further to:
determine that information in the message matches information stored in the first user device; and
replace, based on determining that the information in the message matches the information stored in the first user device and after receiving the information regarding the edit, at least a portion of the information stored in the first user device with the replaced segment.

14. The device of claim 8, where the processor is further to:
store information regarding a plurality of edits, the plurality of edits including the edit; and
provide, for display, a list including the information regarding the plurality of edits,
where the list is provided to the second user device.

15. A computer-readable medium for storing instructions, the instructions comprising:
one or more instructions, which, when executed by a processor of a first user device, cause the processor to:
receive information regarding an edit to a segment of a message in a text-based communication between the first user device and a second user device,
the message having been sent by the first user device and received by the second user device, and
the information regarding the edit entered at the first user device;
determine a location in the message that corresponds to the information regarding the edit;
determine a particular quantity of characters associated with the information regarding the edit;
replace the segment of the message with the particular quantity of characters;
provide the replaced segment and a command to the second user device,
the command being used by the second user device to:
replace the segment of the message with the replaced segment, and
display the message including the replaced segment; and
provide alert information at the second user device,
the alert information including an indication associated with the replaced segment.

16. The computer-readable medium of claim 15, where the alert information includes at least one of:
a pop-up window that includes information regarding the edit, or
a text box that includes information regarding the edit.

17. The computer-readable medium of claim 15, where the one or more instructions are further to cause the processor to:
provide the message within a text box of a display of the first user device; and
modify at least one characteristic of the text box based on the replaced segment.

18. The computer-readable medium of claim 15, where the one or more instructions are further to cause the processor to:
parse the message to determine a quantity of characters included in the message;
create, based on parsing the message, an index associated with the parsed message;
determine a location, in the index, associated with the edit; and
provide the replaced segment and information associated with the index,
the information associated with the index being used to provide the replaced segment for display.

19. The computer-readable medium of claim 15, where the one or more instructions are further to cause the processor to:
determine that information in the message matches information stored in the first user device; and
replace, based on determining that the information in the message matches the information stored in the first user device and after receiving the information regarding the edit, at least a portion of the information stored in the first user device with the replaced segment.

20. The computer-readable medium of claim 15, where the one or more instructions are further to cause the processor to:
store information regarding a plurality of edits, the plurality of edits including the edit; and
provide, for display, a list including the information regarding the plurality of edits,
where the list is provided to the second user device.
